(19) United States
(12) Patent Application Publication
(10) Pub. No.: US 2020/0140044 A1
(43) Pub. Date: May 7, 2020

(54) BOAT STABILIZER SYSTEM BASED ON RADAR

(71) Applicant: Continental Automotive Systems, Inc., Auburn Hills, MI (US)

(72) Inventors: Matthew C. Seville, II, Lake Orion, MI (US); Jean-Christophe Deniau, Fenton, MI (US); Bujji Guthikonda, Troy, MI (US)

(73) Assignee: Continental Automotive Systems, Inc., Auburn Hills, MI (US)

(21) Appl. No.: 16/180,894

(22) Filed: Nov. 5, 2018

(51) Int. Cl. B63B 39/00; B63B 39/04; B63B 39/06; G01S 13/95

(52) U.S. Cl. CPC B63B 39/005; G01S 13/956; B63B 39/06; B63B 39/04

(57) ABSTRACT

A boat stabilization system includes a first radar unit constructed and arranged to be associated with a port side of a boat so as to obtain wave data of a port side wave prior to the port side wave contacting the port side of the boat. A second radar unit is constructed and arranged to be associated with a starboard side of the boat so as to obtain wave data of a starboard side wave prior to the starboard side wave contacting the starboard side of the boat. A control unit is connected with each of the first and second radar units and constructed and arranged to develop, based on the wave data of the port side wave and the starboard side wave, a three-dimensional wave map. The control unit is constructed and arranged to control a boat stabilizing device based on the wave map.

### TECHNICAL FIELD

The present disclosure relates to boat stabilization and, more particularly, to a boat stabilizer system that uses radar to monitor waves that are approaching the boat.

### BACKGROUND

Seasickness, also known as kinetosis and travel sickness, is the state of being dizzy or nauseated due to motions that occur while traveling in or on a moving vehicle. Seasickness is caused by a disagreement between visually perceived movement and the vestibular system's sense of movement. Seasickness is worsened when the waves around a boat contact the boat in the direction of the beam (at the sides of the boat).

Several conventional systems exist to minimize the rocking of the boat that causes seasickness. Such systems are based on gyroscope, Magnus effect or can include stabilizing fins. These conventional systems however, are reactive, meaning that the waves need to first contact the boat for the system to begin to compensate for the side-to-side rocking.

Thus, there is a need to provide a boat stabilizer system that uses radar to monitor waves prior to the waves striking the boat so as to better compensate for side-to-side rocking of the boat once the waves contact the boat.

### SUMMARY

An objective of the invention is to fulfill the need referred to above. In accordance with the principles of an embodiment, this objective is obtained by providing a boat stabilization system including a first radar unit constructed and arranged to be associated with a port side of a boat so as to obtain wave data of a port side wave prior to the port side wave contacting the port side of the boat. A second radar unit is constructed and arranged to be associated with a starboard side of the boat so as to obtain wave data of a starboard side wave prior to the starboard side wave contacting the starboard side of the boat. A control unit is connected with each of the first and second radar units and is constructed and arranged to develop, based on the wave data of the port side wave and the starboard side wave, a three-dimensional wave map. The control unit is constructed and arranged to control a boat stabilizing device based on the wave map.

In accordance with another aspect of an embodiment, a method stabilizes a boat that is experiencing waves contacting the boat. The method provides a first radar unit at a port side of the boat and a second radar unit at a starboard side of the boat. Wave data of a port side wave is obtained with the first radar unit prior to the port side wave contacting the port side of the boat. Wave data of a starboard side wave is obtained with the second radar unit prior the starboard side wave contacting the starboard side of the boat. A processor circuit develops a three-dimensional wave map based on the wave data of the port side wave and the starboard side wave. Based on the wave map, a boat stabilizing device is controlled to counteract effects of the port side wave and the starboard side wave when the waves contact the boat.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The present disclosure will become more fully understood from the detailed description and the accompanying drawings, wherein:

FIG. 1 is a block diagram of a boat stabilizer system provided in accordance with an embodiment of the invention.

FIG. 2 plan view of a boat showing radar units of the boat stabilizer system of FIG. 1 for monitoring waves approaching the starboard and port of the boat.

FIG. 3 is a schematic illustration of wave map created from radar outputs of the radar units of FIG. 2, as the waves approach the boat.

FIG. 4 shows an embodiment of the stabilizing device having a flywheel.

FIG. 5 shows an embodiment of the stabilizing device having a pair of fins.

### DETAILED DESCRIPTION OF EXEMPLARY EMBODIMENTS

The following description is merely exemplary in nature and is in no way intended to limit the disclosure, its application, or uses. For purposes of clarity, the same reference numbers will be used in the drawings to identify similar elements.

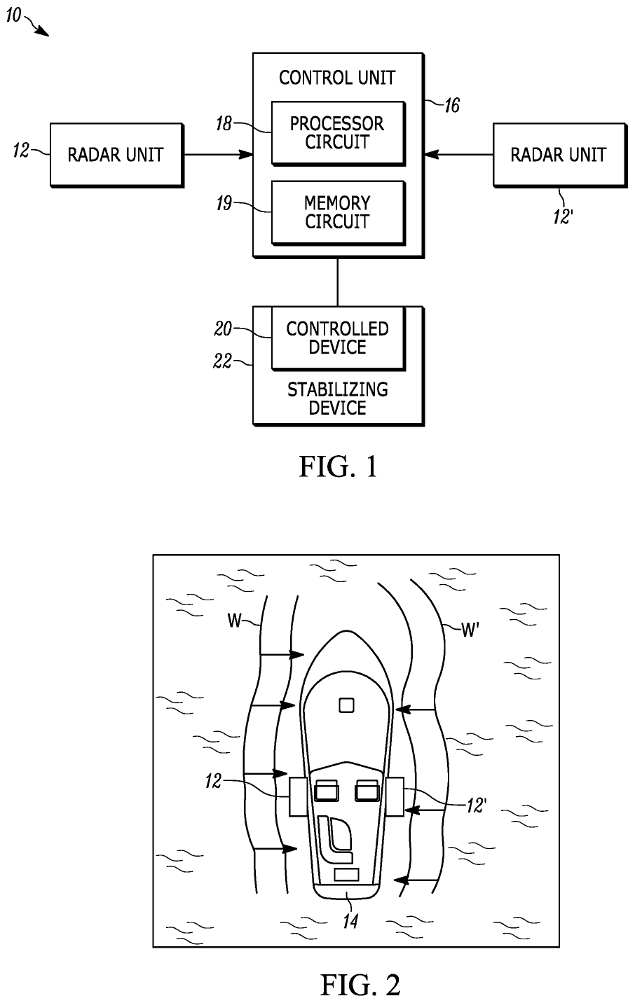

With reference to FIG. 1, a boat stabilizer system is shown, generally indicated at 10, in accordance with an embodiment. As shown in FIGS. 1 and 2, the system 10 includes a first long range radar unit 12, constructed and arranged to be mounted at the port side of a boat 14 to monitor, in real time, waves W approaching the port side of the boat 14, prior to contacting the boat. A second long range radar unit 12′ is constructed and arranged to be mounted at the starboard side of the boat 14 to monitor, in real time, waves W′ approaching the starboard side of the boat 14, prior to contacting the boat.

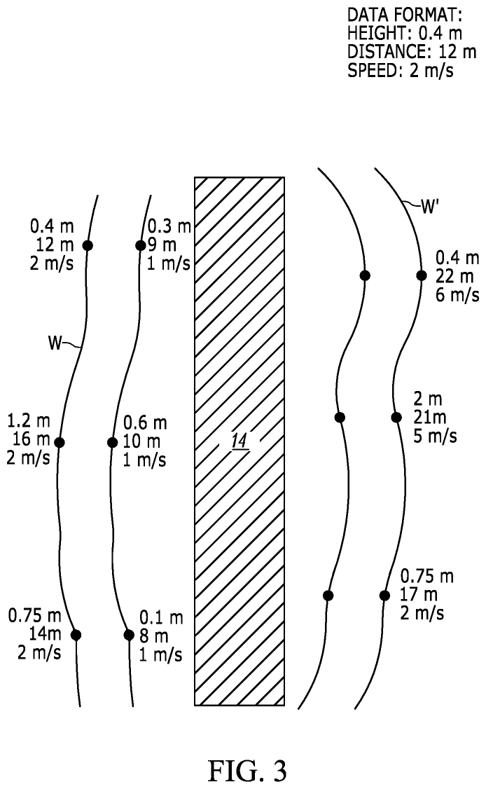

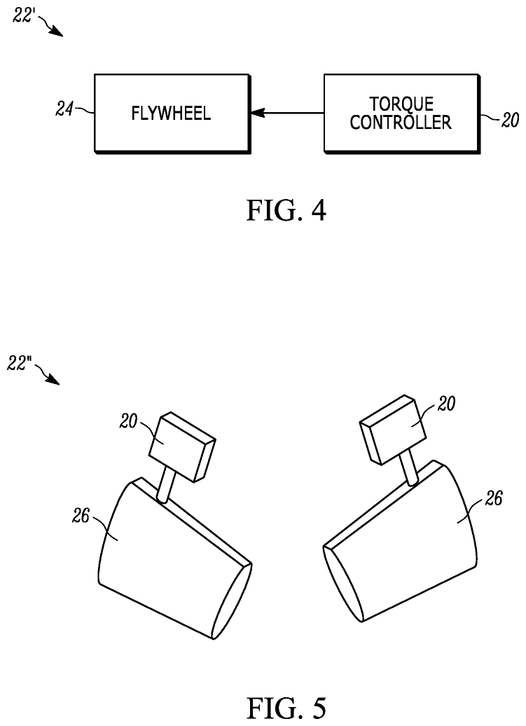

As shown in FIG. 1, each radar unit 12, 12′ can be identical and preferably is of the type used in automotive advanced driving assistance systems. For example, each radar unit can be the Advanced Radar Sensor-ARS-441 manufactured by Continental AG that is electrically connected with a control unit 16 so that the control unit receives the data outputted from the radar units 12, 12′. The control unit includes a processor circuit 18 constructed and arranged to develop a three-dimensional and time based wave map from the data received from the radar units 12, 12′. The wave map can be stored in a memory circuit 19. An example of a wave map is shown in FIG. 3, which maps a wave W moving towards the boat 14 at a port side and maps a wave W′ moving towards the boat 14 at the starboard side. The wave map includes the height, distance from the boat and speed of a wave at various locations along the monitored wave. For example, as shown in FIG. 3, a portion of the wave W at the port side at one instant in time has a height of 0.4 m, is a distance of 12 m from the boat 14, and is traveling at a speed of 2 m/s. As time passes, the wave W has a height of 0.3 m, is a distance of 9 m from the boat 14 and is travelling at 1 m/s. The data in the wave map is employed by the processor circuit 18 to determine the expected roll angle and roll rate of the boat once the waves contact the boat. Thus, based on the predictive wave map, the control unit 16 operates a controlled device 20 of a boat stabilizing device 22 to counteract the effects of the port side wave and starboard side wave striking the boat 14.

As shown in FIG. 5, the stabilizing device 22′ is conventional and can be a gyroscope-type boat stabilizing device having a flywheel 24 as disclosed, for example in U.S. Pat. No. 6,973,847, the content of which is hereby incorporated by reference into this specification. The controlled device 20 is then a torque controller such that based on the wave map, the torque controller 20 can apply torque to the flywheel about the gimbal axis in opposition to the gyro-precession torque to stabilize the boat 14 by counteracting the effects predicted by the wave map.

Alternatively, as shown in FIG. 6, the stabilizing device 22″ can be a fin system comprising at least a pair of fins 26, for example, as disclosed in U.S. Pat. No. 9,527,556, the contents of which is hereby incorporated by reference into this specification. Thus, one fin 26 is mounted on the hull of the boat 14 near port side, with the other fin 26 being mounted on the hull near the starboard side. The controlled device 20 is an actuator associated with each fin 26 (or can be a common actuator that actuates the fins simultaneously) such that based on the wave map, the actuator 20 controls the associated fin 26 to rotate. For example, if the wave map predicts that the boat 14 will roll to starboard, the fins 26 will be actuated to turn counter-clockwise to counter the rolling motion once the waves contact the boat.

Thus, with two or more radar units 12, 12′, the stabilizer system 10 is predictive since wave data is obtained prior to waves contacting boat. Thus, the system 10 can better compensate for waves contacting the beam of the boat 14, thus reducing seasickness.

The operations and algorithms described herein can be implemented as executable code within the control unit 16 having the processor circuit 18 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 19 can be implemented, for example, using a non-volatile memory such as a programmable read only memory (PROM) or an EPROM, and/or a volatile memory such as a DRAM, etc.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A boat stabilization system comprising:
a first radar unit constructed and arranged to be associated with a port side of a boat so as to obtain wave data of a port side wave prior to the port side wave contacting the port side of the boat,
a second radar unit constructed and arranged to be associated with a starboard side of the boat so as to obtain wave data of a starboard side wave prior to the starboard side wave contacting the starboard side of the boat, and
a control unit connected with each of the first and second radar units and constructed and arranged to develop, based on the wave data of the port side wave and the starboard side wave, a three-dimensional wave map, the control unit being constructed and arranged to control a boat stabilizing device based on the wave map.

2. The system of claim 1, in combination with the boat stabilizing device, the boat stabilizing device including a controlled device connected with the control unit such that based on the wave map, the control unit operates the controlled device to permitting the stabilizing device to counteract effects of the port side wave and starboard side wave contacting the boat.

3. The system of claim 1, wherein each of the first and second radar units is a long range radar sensor.

4. The system of claim 2, wherein the stabilizing device is a gyro-type stabilizer having a flywheel and the controlled device is a torque controller configured to control torque of the flywheel.

5. The system of claim 2, wherein the stabilizing device includes a first fin constructed and arranged to be mounted on a hull near a starboard side of the boat and a second fin constructed and arranged to be mounted on the hull near a port side of the boat, the controlled device being an actuator associated with a respective fin for rotating the respective fin.

6. The system of claim 1, wherein the wave data includes at a particular time 1) a height of a portion of the starboard wave, a distance the portion of the starboard wave is from the starboard side of the boat, and speed of the portion of the starboard wave, and 2) a height of a portion of the port wave, a distance the portion of the port wave is from the port side of the boat, and speed of the portion of the port wave.

7. A method of stabilizing a boat that is experiencing waves contacting the boat, the method including the steps of:
providing a first radar unit at a port side of the boat and a second radar unit at a starboard side of the boat,
obtaining, with the first radar unit, wave data of a port side wave prior to the port side wave contacting the port side of the boat,
obtaining, with the second radar unit, wave data of a starboard side wave prior the starboard side wave contacting the starboard side of the boat,
developing, with a processor circuit, a three-dimensional wave map based on the wave data of the port side wave and the starboard side wave, and
based on the wave map, controlling a boat stabilizing device to counteract effects of the port side wave and the starboard side wave when the waves contact the boat.

8. The method of claim 7, wherein the wave data includes at a particular time 1) a height of a portion of the starboard wave, a distance the portion of the starboard wave is from the starboard side of the boat, and speed of the portion of the starboard wave, and 2) a height of a portion of the port wave, a distance the portion of the port wave is from the port side of the boat, and speed of the portion of the port wave.

9. The method of claim 7, wherein the stabilizing device is a gyro-type stabilizer having a flywheel and the step of controlling the stabilizing device includes controlling torque of the flywheel.

10. The method of claim 7, wherein the stabilizing device includes a first fin mounted on a hull near a starboard side of the boat and a second fin mounted on the hull near port side of the boat, and the step of controlling the stabilizing device includes rotating the fins.

11. The method of claim 7, wherein the step of providing first and second radar units includes providing the radar units as long range radar sensors.
